(19) United States
(12) Patent Application Publication
(10) Pub. No.: US 2008/0316461 A1
(43) Pub. Date: Dec. 25, 2008

(54) Lithographic apparatus and device manufacturing method

(75) Inventor: Rene Theodorus Petrus Compen, Valkenswaard (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 11/812,818

(22) Filed: Jun. 21, 2007

(51) Int. Cl. G03B 27/60

(52) U.S. Cl. 355/73; 355/77

(57) ABSTRACT

The present invention relates to a clamping device configured to clamp an object on a support, comprising a first device configured to exert an attracting force on said object, and a second device configured to exert a rejecting force on said object, wherein said first device and second device are configured to simultaneously exert an attracting and a rejecting force on said object to shape said object to a desired shape before clamping of said object on said support. The invention further relates to a method for loading an object on a support, comprising the steps of shaping said object in a desired shape spaced from said support, wherein said shaping comprises subjecting said object simultaneously to an attracting force pulling said object towards said support and a rejecting force pushing said object away from said support, and clamping said object on said support.

### BACKGROUND

1. Field of the Invention

The present invention relates to a clamping device and a method for clamping an object on a support. The present invention further relates to a lithographic apparatus and a method for clamping a substrate on a substrate support of a lithographic apparatus.

2. Description of the Related Art

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g., including part of, onle, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In the known lithographic apparatus each substrate to be exposed, is loaded on a substrate support on which the substrate is supported during the exposure of a patterned beam of radiation. To clamp the substrate on the substrate support a clamping device is provided. In a known embodiment of the lithographic apparatus a vacuum clamping device is used. Such vacuum clamping device provides a vacuum force with which the substrate is clamped on the supporting surface of the substrate support. In the case a substrate is straight, the substrate will be clamped on the support surface without any substantial internal stresses in the substrate.

However, substrates may not be straight, but for instance be warped in a number of shapes, such as a corrugated shape, cylindrical shape, dome shaped, a saddle form or another shape. This may be caused by the production method used to make the substrate, or by pre-or post exposure processes to which the substrates are subjected during the manufacture.

When a warped substrate, for instance a dome-shaped substrate is clamped on a substrate support for instance by means of a vacuum clamp, the substrate may first contact with the substrate support at the outer circumference of the substrate and thereafter over the rest of the surface of the substrate. Due to the clamping force the substrate is forced into a substantially straight form, while the clamping is started at the outer circumference of the substrate. As a result, stresses may be induced in the substrate when it is clamped on the supporting surface.

These stresses may have a negative influence on the final product quality. Also, since the substrate is clamped in another form than desired, the overlay performance of the projections of the lithographic apparatus may decrease which may have a negative influence on product quality.

### SUMMARY

Applicants have determined that it may be desirable to provide a substrate support having a holding arrangement for substrates, wherein internal stresses in a substrate due to clamping forces are substantially decreased. Furthermore, it may be desirable to provide a clamping method with which a warped substrate may be clamped on a substrate support thereby potentially decreasing the risk on stresses in the substrate and/or overlay errors.

According to an aspect of the invention, there is provided a clamping device configured to clamp an object on a support, including a first device configured to exert an attracting force on said object, and a second device configured to exert a rejecting force on said object, wherein said first device and second device are configured to simultaneously exert an attracting and a rejecting force on said object to shape said object to a desired shape before clamping of said object on said support.

According to an aspect of the invention, there is provided a method for loading an object on a support, including shaping said object in a desired shape spaced from said support, wherein said shaping comprises subjecting said object simultaneously to an attracting force pulling said object towards said support and a rejecting force pushing said object away from said support, and clamping said object on said support.

According to an aspect of the invention, there is provided a method for loading a substrate on a substrate support of a lithographic apparatus, said method including shaping said substrate in a desired shape spaced from said substrate support, wherein said shaping comprises subjecting said substrate simultaneously to an attracting force pulling said object towards said support and a rejecting force pushing said substrate away from said support, and clamping said shaped substrate on said substrate support.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a side view of a substrate support according to the invention;

FIG. 3 depicts a top view of the substrate support of FIG. 2;

FIGS. 4a, 4b and 4c are diagrams showing exampled of the dependence of the attracting force and the rejecting force on the distance between the substrate and the substrate support; and

FIGS. 5a-5c depict three steps of the method according to the invention.

### DETAILED DESCRIPTION

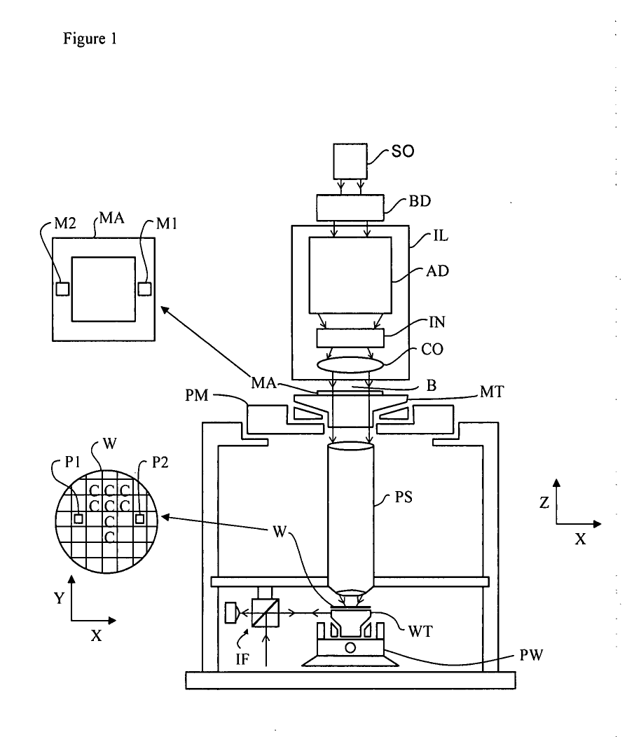

FIG. 1 schematically depicts a lithographic apparatus according to one embodiment of the invention. The apparatus includes an illumination system (illuminator) IL configured to condition a radiation beam B (e.g., UV radiation or any other suitable radiation), a mask support structure (e.g., a mask table) MT constructed to support a patterning device (e.g., a mask) MA and connected to a first positioning device PM configured to accurately position the patterning device in accordance with certain parameters. The apparatus also includes a substrate table (e.g., a wafer table) WT or “substrate support” constructed to hold a substrate (e.g., a resist-coated wafer) W and connected to a second positioning device PW configured to accurately position the substrate in accordance with certain parameters. The apparatus further includes a projection system (e.g., a refractive projection lens system) PS configured to project a pattern imparted to the radiation beam B by patterning device MA onto a target portion C (e.g., including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The mask support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The mask support structure can use mechanical, vacuum, electrostatic or other clamping techniques to hold the patterning device. The mask support structure may be a frame or a table, for example, which may be fixed or movable as required. The mask support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system.”

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the mask support structure (e.g., mask table MT), and is patterned by the patterning device. Having traversed the mask MA, the radiation beam B passes through the projection system PS, which focuses the beam onto a target portion C of the substrate W. With the aid of the second positioning device PW and position sensor IF (e.g., an interferometric device, linear encoder or capacitive sensor), the substrate table WT can be moved accurately, e.g., so as to position different target portions C in the path of the radiation beam B. Similarly, the first positioning device PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT or “mask support” and the substrate table WT or “substrate support” are kept essentially stationary, while an entire pattern imparted to the radiation beam is projected onto a target portion C at one time (i.e., a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the mask table MT or “mask support” and the substrate table WT or “substrate support” are scanned synchronously while a pattern imparted to the radiation beam is projected onto a target portion C (i.e., a single dynamic exposure). The velocity and direction of the substrate table WT or “substrate support” relative to the mask table MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

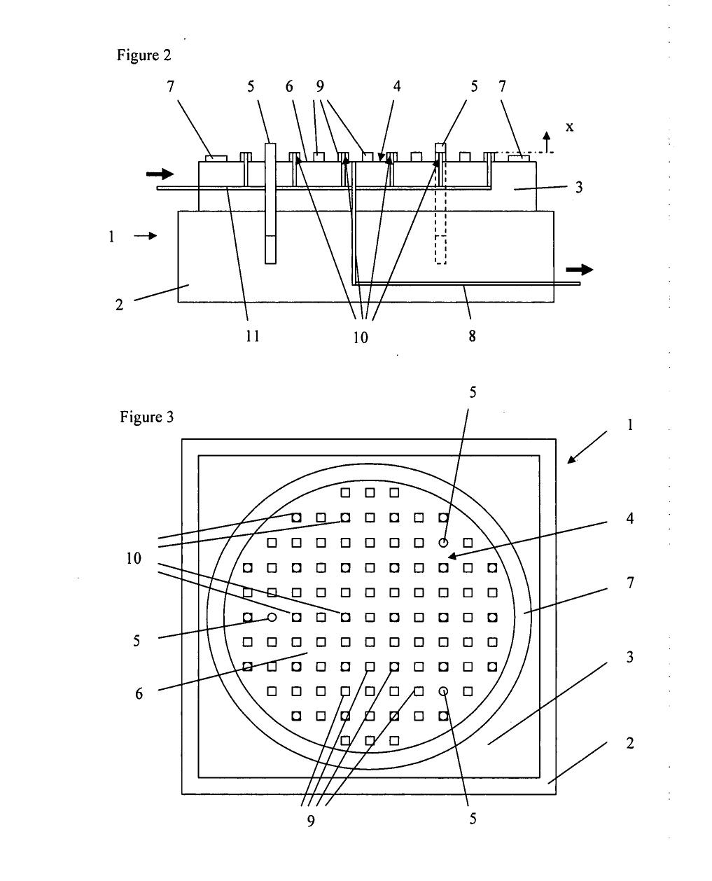

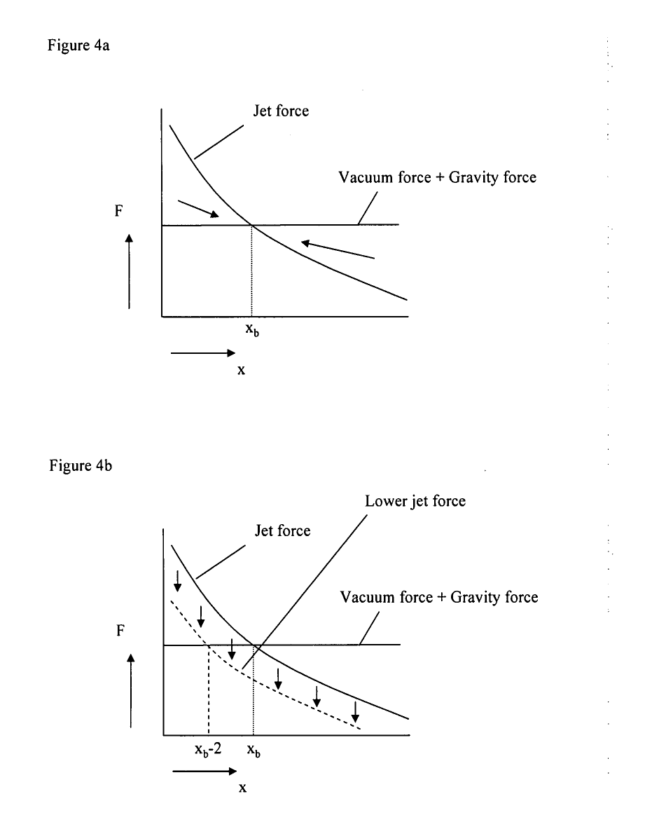

FIGS. 2 and 3 show a side view and top view of a substrate support according to the invention, respectively. The substrate support is generally indicated with the reference numeral 1. The substrate support 1 comprises a mirror block 2 on which a substrate table 3 is placed.

The top side of the substrate support 1 comprises a vacuum clamp 4 to clamp a substrate on the substrate support 1. The substrate support 1 comprises further three retractable pins 5, often referred to as e-pins, which are movable with respect to the substrate support between an extended position in which the pins 5 extend from the substrate support 1 and a retracted position in which the pins 5 are retracted in the substrate support 1. The retractable pins 5 are movable in a substantially vertical direction, i.e., in a direction substantially perpendicular to a main plane of a substrate to be supported by the pins. The retractable pins 5 may be used for transfer of a substrate between the substrate support 1 and a robot or any other type of substrate handler. The retractable pins 5 are provided so that a robot may be placed under the substrate for supporting it. When the robot is configured to hold the substrate at the sides or top, the retractable pins 5 may be omitted.

A robot may place a substrate on the pins 5 in the extended position. Then the pins 5 may be moved to the retracted position so that the substrate comes to rest on the support surface of the substrate support 1. After a substrate supported by the substrate support 1 is exposed to a patterned beam of radiation, it may be exchanged for another one. For exchange of the substrate it is lifted from the substrate table 3 by the retractable pins 5 which are moved from the retracted position to the extended position. When the pins 5 are in the extended position, the substrate may be taken over by the robot or any other type of substrate handler.

The vacuum clamp 4 is formed by a recessed surface 6 which is surrounded by a sealing rim 7. An air suction conduit 8 is provided to make the creation of a low pressure in a vacuum space delimited by the recessed surface 6, the sealing rim 7 and a substrate placed or to be placed on the substrate support 1. The air suction conduit 8 is connected to an air suction pump to draw air out of the vacuum space. The lower pressure provides a vacuum force which draws a substrate placed within a certain range above the supporting surface towards the substrate support 1. In this range, or at least a part thereof, the vacuum force exerted on the substrate may be substantially independent of the distance x between the substrate support and the substrate.

In the recessed surface 6 a number of burls 9 are arranged. The top ends of the burls 9 provide support surfaces for a substrate to be placed on the substrate support 1. The sealing rim 7 and the top ends of the burls 9 may be arranged in substantially the same plane to provide a substantial flat surface for supporting a substrate. In an alternative embodiment the sealing rim 7 may be arranged lower than the burls 9, as shown in FIG. 2, or vice versa.

In an embodiment of the substrate support 1 two or more vacuum clamps may be provided. Also another device for providing an attracting force exerted on the substrate may be provided, such as an electrostatic, magnetic, or electromagnetic clamp. The force exerted by such clamp is preferably in a range above a supporting surface of the substrate support 1 independent of the distance x between the substrate support and the substrate.

In a number of burls 9 nozzles 10 are provided. In the embodiment shown in FIGS. 2 and 3 the nozzles 10 are evenly distributed over the surface area delimited by the sealing rim 7. The nozzles 10 are connected to an air supply conduit 11 and are configured to provide a jet in a direction substantially perpendicular to the recessed surface, i.e., substantially perpendicular to the main plane of a substrate to be arranged on the substrate support 1. To actually provide a jet, an air pump (not shown), or another source of pressurized air, is connected to the supply conduit 11. In an alternative embodiment of the substrate support the nozzles 10 are not integrated in the burls, but separately provided. It is remarked that for the provision of the jets any other type of suitable gas may also be used.

A substrate placed in the above-mentioned range is subject to a force exerted by the air jet which is dependent on the distance x between the substrate support 1 and the substrate.

In an alternative embodiment other devices may be provided to provide a rejecting force. The rejecting force exerted on the substrate preferably decreases with increasing distance x between substrate support 1 and substrate. Such device may for instance include linear or non-linear springs.

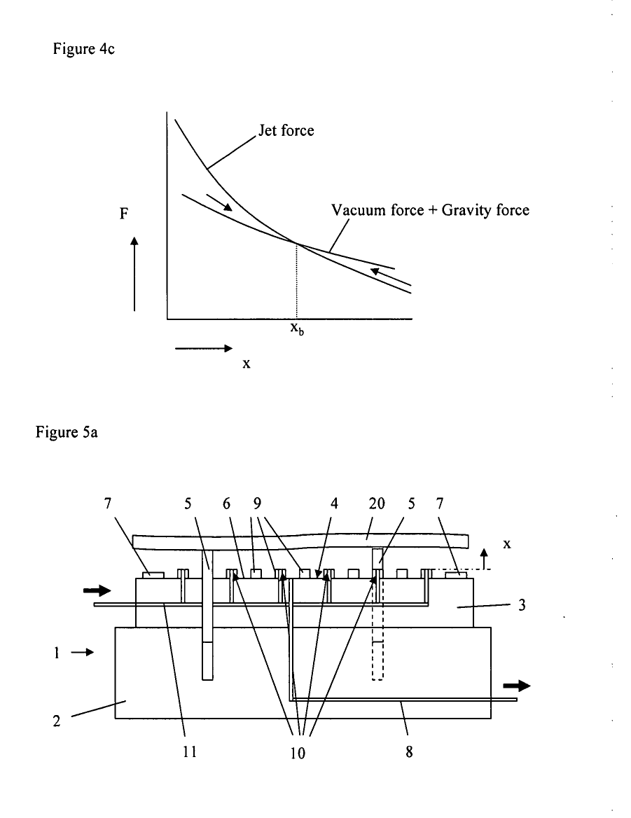

In FIG. 4a the attracting vacuum force plus gravity force, and the rejecting jet force exerted on the substrate in dependence on the distance x of the substrate from the substrate support. On the x-axis the distance x between the substrate support and the substrate is indicated for a certain range. On the y-axis the attracting force (combination of vacuum force and gravity force) and the rejecting force (jet force) are shown in dependence of the distance x.

It can be seen that, in the shown range, the attracting force is independent of the distance x. The rejecting force caused by the airjets decreases with increasing distance x. At the balance distance x_{b}, the attracting force and the rejecting force are equal. When a substrate is present at this balance distance it will be held at this distance since these forces are equal. At distances larger than x_{b} the attracting force is larger than the rejecting force and as a result the substrate will move towards the substrate support, therewith decreasing the distance x. At distances smaller than x_{b} the attracting force will be smaller than the rejecting force, and the substrate will be moved away from the substrate support to the balance position x_{b}. In this way the substrate may be held and moved towards a balance position x_{b} as indicated by arrows in FIG. 4a.

Furthermore, not only the substrate as a whole will be moved towards the balance position. The balance between the attracting force and the rejecting force may also be used to shape the warped substrate to a desired shape. This may be advantageous in the case a substrate to be loaded on the substrate support is warped. When the balance distance x_{b} is equal for the whole surface area of a substrate supported on said substrate support, the warped substrate may be straightened at the distance x_{b}, by balancing it for a certain time at this distance using the attracting and rejecting forces of the substrate support before it is clamped on the supporting surface of the substrate support.

In an embodiment, the straightening, or more generally the shaping may also be performed, while the substrate is moved towards the substrate support. In such embodiment the balance distance x_{b} is decreased during shaping therewith moving the substrate towards the substrate support. The change in balance distance may be obtained by changing the attracting force and/or the rejecting force accordingly. For instance, in FIG. 4b is shown in dashed lines that the rejecting force is lowered resulting in another balance distance x_{b}-2, which is closer to the substrate support.

In an embodiment, unevenly distributed attracting and/or rejecting forces may be provided, for instance by an unevenly distributed number of air nozzles or a difference in the air jetting force or vacuum force by using different air supply conduits or two or more vacuum clamps, preferably having an own air suction conduit. In such embodiment the balance distance x_{b} may be varied along the surface area of the substrate and as a result the substrate may be formed in a desired shape.

In an embodiment, it may be possible that both forces depend on the distance x between the substrate support 1 and the substrate 20. For instance, in FIG. 4c the attracting force, i.e., vacuum force plus gravity force, and the rejecting force, i.e., jet force, exerted on the substrate both decrease with increasing distance between the substrate support and the substrate. However, at shorter distances, smaller than x_{b} the rejecting force is larger and at distances larger than x_{b} the attracting force is larger. Thus the substrate will be held at the distance x_{b}, therewith creating the possibility of shaping the substrate, for instance straightening a warped substrate before clamping it on the substrate support.

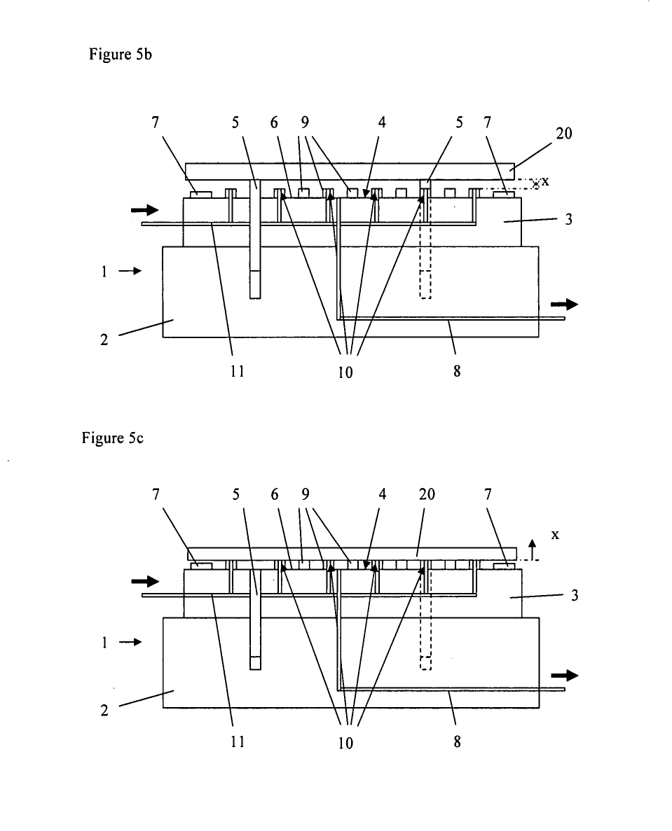

FIGS. 5a-5c show some steps of a clamping method according to the invention for clamping a warped substrate 20 on a substrate support 1.

FIG. 5a shows the substrate support of FIG. 2 whereby a substrate 20 is placed on the retractable pins 5. The substrate 20 is warped, which for instance may be caused by a pre- or post exposure process such as coating, baking, chilling or developing of the substrate. The height differences in the substrate are typically in the range of 5-50 micrometers, in particular for relative new substrates, which do not have been processed, for instance coated, baked, chilled and developed, but differences up to 450 micrometers or even more are also possible, in particular after the substrates have been processed.

When such a warped substrate is loaded on the substrate support without further measures, the stresses may be introduced in the substrate 20 due to the clamping of the substrate 20 in the warped form. For instance, when the substrate is dome-shaped, first the outer circumference may be clamped and thereafter the middle of the substrate 20 is clamped. As the circumference of the warped substrate may be smaller than the circumference of the same straightened substrate, the clamping may result in stresses in the substrate.

In FIG. 5b the substrate 20 is moved downwards by retracting the pins 5 in the substrate support 1 to bring the substrate close to the balance position, i.e., the distance x between substrate 20 and substrate support 1 close to x_{b}. It is remarked that the balance distance x_{b} may typically lie within the range 1-1000 micrometer, preferably in the range 1-100 micrometer. The preferred balance distance may also depend on the height differences which are present in the respective substrate.

To shape a warped substrate an attracting force and a rejecting force are simultaneously exerted on the substrate. The magnitude of these forces may be altered to change the balance position of the substrate.

Thereby, it may be possible that the substrate is shaped during movement of the substrate towards the substrate support. Also, the substrate may be shaped during a first approach of the substrate support and then be held at a certain distance, for instance between 1 and 100 micrometer to be further shaped to a substantially flat form before it is clamped on the substrate support.

Since the substrate 20 floats on the air bed created by the air jets, it is desirable that some fixation for the substrate is provided. For this reason the substrate 20 is still held by the retractable pins 5 for fixation in the x, y and Rz directions. However, to make the influence of the presence of the pins 5 on the straightening as small as possible, the pins have at least during the straightening phase a low stiffness in the vertical z-direction. Any other device for maintaining the substrate in substantially the same position in x, y and Rz directions may be also used.

When the straightening of the substrate 20 has finished, the substrate 20 is clamped on the substrate support 1 by making the attracting force larger than the rejecting force, for instance by increasing the vacuum force of the vacuum clamp 4 or by decreasing the velocity of the jets coming from the nozzles 10. As a consequence the substrate 20 comes to rest on the support surface of the substrate support 1. When the vacuum force is maintained the substrate 20 is clamped on the substrate support 1 while still being in a substantially straightened shape.

In FIG. 5c, the substrate 20 is shown clamped on the substrate support 1 using the vacuum clamp 4. Since the substrate 20 is straightened during clamping on the substrate support the risk on internal stresses in the substrate 20 is substantially reduced and the overlay performance is therewith increased. The retractable pins 5 are moved to the retracted position.

It is remarked that the straightening phase may also be used for thermal conditioning of the substrate 20 by temperature control of the air used for the jets.

Above the use of a device and method for controlling the shape of an object before clamping it on a support is explained at the hand of a substrate support 1 and a substrate 20 to be clamped on such support. Such device and method may be used for clamping another object, in particular a warped plane-shaped object, such as a warped plate or sheet, on a support in order to control the shape in which the object is clamped on the support, in particular to avoid internal stresses in said object after clamping. Such embodiments are deemed to fall within the scope of the present invention.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 248, 193, 157 or 126 nm) and extreme ultra-violet (EUV) radiation (e.g., having a wavelength in the range of 5-20 nm), as well as particle beams, such as ion beams or electron beams.

The term “lens,” where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A clamping device configured to clamp an object on a support, comprising:
a first device configured to exert an attracting force on said object, and
a second device configured to exert a rejecting force on said object,
wherein said first device and second device are configured to simultaneously exert an attracting and a rejecting force on said object to shape said object to a desired shape before clamping of said object on said support.

2. The clamping device of claim 1, wherein said first device and second device are configured to simultaneously exert an attracting and rejecting force such that at a balance distance above said support said attracting force and a gravity force on said object are equal to the rejecting force.

3. The clamping device of claim 2, wherein said object is held at said balance distance during at least a period of said shaping of said object.

4. The clamping device of claim 2, wherein said first device and second device are configured to change said balance distance during shaping to move said object during at least a period of said shaping towards said support.

5. The clamping device of claim 1, wherein in a certain range said attracting force is substantially independent of a distance between said support and said object, and wherein said rejecting force is dependent on said distance, the force decreasing at an increasing distance between said object and said support.

6. The clamping device of claim 1, wherein said attracting force is dependent on a distance between said object and said support and wherein said rejecting force is dependent on said distance, wherein in a distance range between said object and said support, said distance range comprises a balance distance, in which the attracting force and the rejecting force are equal.

7. The clamping device of claim 6, wherein in said distance range at distances smaller than said balance distance said rejecting force is larger than said attracting force and at distances larger than said balance distance said rejecting force is smaller than said attracting force.

8. The clamping device of claim 1, wherein said first device comprises at least one vacuum clamp.

9. The clamping device of claim 1, wherein said second device comprises a number of nozzles.

10. The clamping device of claim 8, wherein said vacuum clamp extends over substantially the whole surface of said object.

11. The clamping device of claim 8, wherein said support comprises a recessed surface surrounded by a sealing rim, said recessed surface forming a vacuum clamp by drawing air out of a space defined by said recessed surface.

12. The clamping device of claim 11, wherein a number of burls are arranged on said recessed surface, said burls providing support surfaces for an object clamped on said support.

13. The clamping device of claim 11, wherein a number of nozzles is provided in said recessed area, said nozzles being connected to a pressure source and arranged to provide a jet of gas towards an object being held above said support.

14. The clamping device of claim 12, wherein said nozzles are integrated in said burls.

15. The clamping device according to claim 1, wherein the object is a wafer.

16. A method for loading an object on a support, comprising the steps of:
shaping said object in a desired shape spaced from said support, wherein said shaping comprises subjecting said object simultaneously to an attracting force pulling said object towards said support and a rejecting force pushing said object away from said support, and
clamping said object on said support.

17. The method of claim 16, wherein said object is held at a certain distance of said support during at least a period of said shaping of said object.

18. The method of claim 16, wherein said object is moved during at least a period of said shaping towards said support.

19. The method of claim 16, wherein said shaping comprises straightening of said object.

20. The method of claim 16, wherein said shaping comprises subjecting said object simultaneously to an attracting force pulling said object towards said object support and a rejecting force pushing said object away from said support.

21. The method of claim 16, wherein said attracting force is at least in a range non-dependent on a distance between said object and said support, and wherein said rejecting force is in said range dependent on said distance.

22. The method of claim 16, wherein said attracting force is dependent on a distance between said object and said support and wherein said rejecting force is dependent on said distance, wherein in a distance range between said object and said support, said distance range comprises a balance distance, in which the attracting force and the rejecting force are equal.

23. The method of claim 22, wherein in said distance range at distances smaller than said balance distance said rejecting force is larger than said attracting force and at distances larger than said balance distance said rejecting force is smaller than said attracting force.

24. The method of claim 16, wherein said attracting force is created by at least one vacuum clamp of said support.

25. The method of claim 16, wherein said attracting force is created by gravity.

26. A lithographic apparatus comprising a substrate support constructed to hold a substrate, wherein said substrate support comprises the clamping device according to claim 1, said support being said substrate support and said object being a substrate to be supported on said substrate support.

27. A method for loading a substrate on a substrate support of a lithographic apparatus, said method comprising:
shaping said substrate in a desired shape spaced from said substrate support, wherein said shaping comprises subjecting said substrate simultaneously to an attracting force pulling said object towards said support and a rejecting force pushing said substrate away from said support, and
clamping said shaped substrate on said substrate support.
